(19) United States
(12) Patent Application Publication
(10) Pub. No.: US 2026/0006569 A1
(43) Pub. Date: Jan. 1, 2026

(54) METHOD AND APPARATUS FOR WAIT TIMER OF NTN STORE AND FORWARD IN A WIRELESS COMMUNICATION SYSTEM

(71) Applicant: ASUS Technology Licensing Inc., Taipei City (TW)

(72) Inventor: Meng-Hui Ou, Taipei City (TW)

(21) Appl. No.: 19/251,576

(22) Filed: Jun. 26, 2025

Related U.S. Application Data
(60) Provisional application No. 63/666,041, filed on Jun. 28, 2024.

(51) Int. Cl. H04W 60/04; H04B 7/185; H04W 84/04

(52) U.S. Cl. CPC H04W 60/04; H04B 7/18513; H04W 84/042

(57) ABSTRACT

Methods, systems, and apparatuses are provided for wait timers of Non-Terrestrial Network (NTN) Store and Forward (S&F) in a wireless communication system, wherein a method for a UE comprises initiating a first procedure to a first network, wherein the first procedure is an attach, tracking area update (TAU) procedure, or a service request procedure, receiving a configuration of a wait time for an S&F operation, starting a first timer based on the wait time, wherein the UE is prohibited to initiate the first procedure to the first network for the S&F operation when the first timer is running, and stopping the first timer if the UE initiates or successfully completes a second procedure in a cell of a second network, wherein the second procedure is an attach, TAU procedure, or a service request procedure.

### CROSS-REFERENCE TO RELATED APPLICATIONS

The present application claims priority to and the benefit of U.S. Provisional Patent Application Ser. No. 63/666,041, filed Jun. 28, 2024, which is hereby fully incorporated herein by reference.

### FIELD

This disclosure generally relates to wireless communication networks and, more particularly, to a method and apparatus for wait timer of Non-Terrestrial Network (NTN) Store and Forward (S&F) in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for wait timer of Non-Terrestrial Network (NTN) Store and Forward (S&F) in a wireless communication system such that User Equipment (UE) can handle wait timer appropriately.

In various embodiments, a method for a UE in a wireless communication system comprises initiating a first procedure to a first network, wherein the first procedure is an attach, tracking area update (TAU) procedure, or a service request procedure, receiving a configuration of a wait time for an S&F operation, starting a first timer based on the wait time, wherein the UE is prohibited to initiate the first procedure to the first network for the S&F operation when the first timer is running, and stopping the first timer if the UE initiates or successfully completes a second procedure in a cell of a second network, wherein the second procedure is an attach, TAU procedure, or a service request procedure.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIGS. 4.1-1: Non-terrestrial network typical scenario based on transparent payload, from 3GPP TR 38.821 V16.0.0.

FIG. 6 is a reproduction of FIGS. 4.1-2: Non-terrestrial network typical scenario based on regenerative payload, from 3GPP TR 38.821 V16.0.0.

FIG. 7 is a reproduction of FIG. 5.2.1-1: Regenerative satellite without ISL, gNB processed payload, from 3GPP TR 38.821 V16.0.0.

FIG. 8 is a reproduction of FIG. 5.2.1-2: Regenerative satellite with ISL, gNB processed payload, from 3GPP TR 38.821 V16.0.0.

FIG. 9 is a reproduction of FIG. 5.2.2-1: NG-RAN with a regenerative satellite based on gNB-DU, from 3GPP TR 38.821 V16.0.0.

FIG. 10 is a reproduction of FIG. A-1: Illustration of “normal/default operation” and “S&F operation” modes in a 5G system with satellite access from 3GPP TR 22.865 V2.0.0.

FIG. 11 is a reproduction of FIG. 6.12.2-1: Attach without PDN connectivity, from 3GPP TR 23.700-29 V1.0.0.

FIG. 12 is an example diagram showing an illustration of an NTN network, in accordance with embodiments of the present invention.

FIG. 13 is an example diagram showing a first procedure, wherein a UE may initiate a first procedure (e.g., to a first network), in accordance with embodiments of the present invention.

FIG. 14 is an example diagram showing an issue where it is not optimal to re-attempt an attach or TAU procedure with the original network (e.g., for S&F) since the UE may lose the chance to get normal service, in accordance with embodiments of the present invention.

FIG. 15 is an example diagram showing a solution to the issue presented in FIG. 14, in accordance with embodiments of the present invention.

FIG. 16 is a flow diagram of a method of a UE in a wireless communication system comprising receiving a configuration of a first timer from a first network, starting the first timer based on the configuration, and stopping the first timer in response to initiating or successfully completing a second procedure or determining to reselect to a second network, in accordance with embodiments of the present invention.

FIG. 17 is a flow diagram of a method of a UE in a wireless communication system comprising initiating a first procedure to a first network, wherein the first procedure is an attach, TAU procedure, or a service request procedure, receiving a configuration of a wait time for an S&F operation, starting a first timer based on the wait time, and stopping the first timer if the UE initiates or successfully completes a second procedure in a cell of a second network, wherein the second procedure is an attach, TAU procedure, or a service request procedure, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] 3GPP TR 38.821 V16.0.0, “Solutions for NR to support non-terrestrial networks (NTN)”; [2] 3GPP TR 22.865 V2.0.0, “Study on satellite access Phase 3 (Release 19)”; [3] 3GPP TR 23.700-29 V1.0.0, “Study on integration of satellite components in the 5G architecture; Phase 3 (Release 19)”; [4] 3GPP S2-2407191, “KI #2: Conclusions”; [5]3GPP TS 23.501 V18.1.0, “System architecture for the 5G system (5GS)”; and [6] 3GPP RWS-230178, “NR and IoT NTN”. The standards and documents listed above are hereby expressly and fully incorporated herein by reference in their entirety.

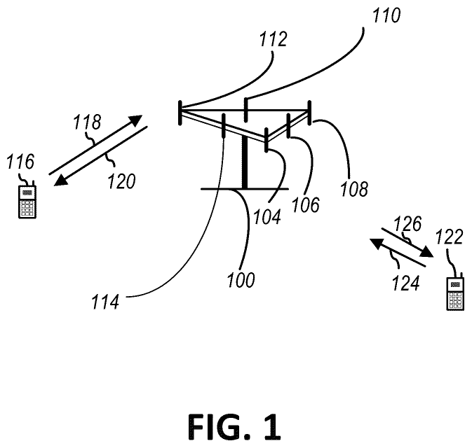

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

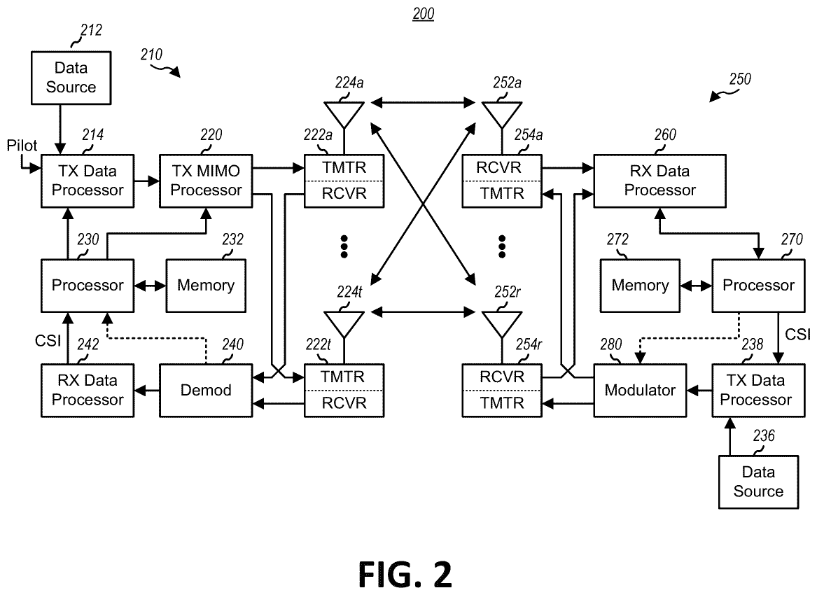

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams.

The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

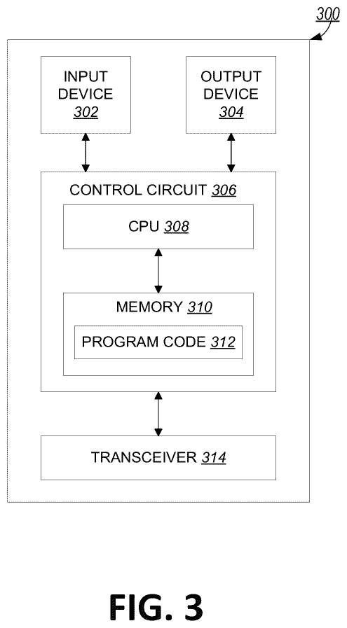

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

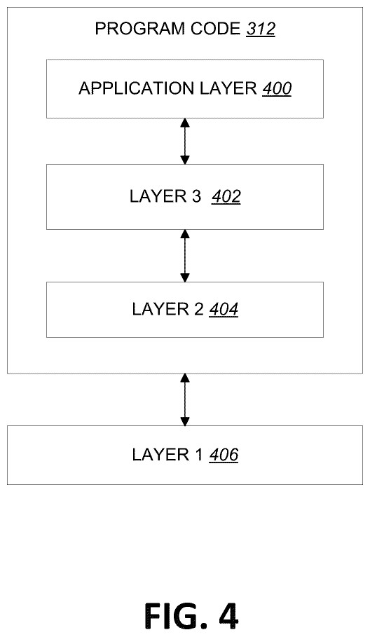

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

****************************************************************************************

In 3GPP TR 38.821 ([1]3GPP TR 38.821 V16.0.0), study on NRNTNs (non-terrestrial networks) are introduced. NTN is defined as networks, or segments of networks, using an airborne or space-borne vehicle to embark a transmission equipment relay node or base station. More descriptions are also specified in [1] 3GPP TR38.821 V16.0.0.

4.1 Non-Terrestrial Networks overview

A non-terrestrial network refers to a network, or segment of networks using RF resources on board a satellite (or UAS platform).

The typical scenario of a non-terrestrial network providing access to user equipment is depicted below:

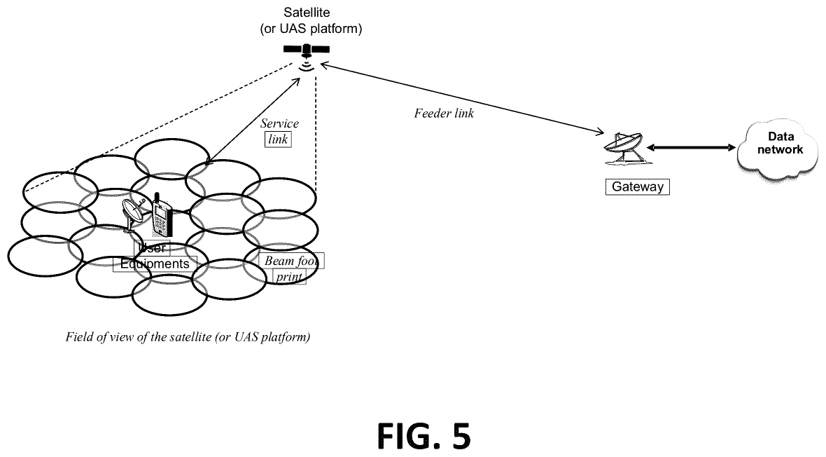

FIG. 5 is a reproduction of FIGS. 4.1-1: Non-terrestrial network typical scenario based on transparent payload, from 3GPP TR 38.821 V16.0.0.

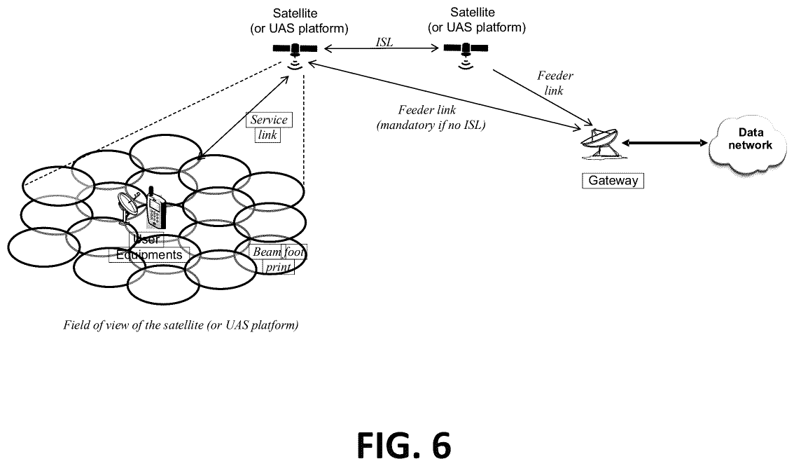

FIG. 6 is a reproduction of FIGS. 4.1-2: Non-terrestrial network typical scenario based on regenerative payload, from 3GPP TR 38.821 V16.0.0.

Non-Terrestrial Network typically features the following elements:
One or several sat-gateways that connect the Non-Terrestrial Network to a public data network
   a GEO satellite is fed by one or several sat-gateways which are deployed across the satellite targeted coverage (e.g. regional or even continental coverage). We assume that UE in a cell are served by only one sat-gateway
   A Non-GEO satellite served successively by one or several sat-gateways at a time. The system ensures service and feeder link continuity between the successive serving sat-gateways with sufficient time duration to proceed with mobility anchoring and hand-over
A Feeder link or radio link between a sat-gateway and the satellite (or UAS platform)
A service link or radio link between the user equipment and the satellite (or UAS platform).
A satellite (or UAS platform) which may implement either a transparent or a regenerative (with on board processing) payload. The satellite (or UAS platform) generate beams typically generate several beams over a given service area bounded by its field of view. The footprints of the beams are typically of elliptic shape. The field of view of a satellites (or UAS platforms) depends on the on board antenna diagram and min elevation angle.
   A transparent payload: Radio Frequency filtering, Frequency conversion and amplification. Hence, the waveform signal repeated by the payload is un-changed;
   A regenerative payload: Radio Frequency filtering, Frequency conversion and amplification as well as demodulation/decoding, switch and/or routing, coding/modulation. This is effectively equivalent to having all or part of base station functions (e.g. gNB) on board the satellite (or UAS platform).
Inter-satellite links (ISL) optionally in case of a constellation of satellites. This will require regenerative payloads on board the satellites. ISL may operate in RF frequency or optical bands.
User Equipment are served by the satellite (or UAS platform) within the targeted service area.

There may be different types of satellites (or UAS platforms) listed here under:

TABLE 4.1-1
Types of NTN platforms

| | Altitude | | | Typical beam | |
|---|---|---|---|---|---|
| Platforms | range | | Orbit | footprint size | |
| Low-Earth Orbit | 300-1500 | km | Circular around | 100-1000 | km |
| (LEO) satellite | | | the earth | | |
| Medium-Earth | 7000-25000 | km | | 100-1000 | km |
| Orbit (MEO) | | | | | |
| satellite | | | | | |
| Geostationary | 35 786 | km | notional station | 200-3500 | km |
| Earth Orbit | | | keeping position | | |
| (GEO) satellite | | | fixed in terms of | | |
| UAS platform | 8-50 km (20 | | elevation/azimuth | 5-200 | km |
| (including HAPS) | km for HAPS) | | with respect to a | | |
| | | | given earth point | | |
| High Elliptical | 400-50000 | km | Elliptical around | 200-3500 | km |
| Orbit (HEO) | | | the earth | | |
| satellite | | | | | |

Typically
GEO satellite and UAS are used to provide continental, regional or local service.
a constellation of LEO and MEO is used to provide services in both Northern and Southern hemispheres. In some case, the constellation can even provide global coverage including polar regions. For the later, this requires appropriate orbit inclination, sufficient beams generated and inter-satellite links.

HEO satellite systems are not considered in this document. [ . . . ]

### 5.2 Regenerative Satellite Based NG-RAN Architectures

### 5.2.1 gNB Processed Payload

### 5.2.1.1 Overview

The NG-RAN logical architecture as described in TS 38.401 is used as baseline for NTN scenarios.

The satellite payload implements regeneration of the signals received from Earth.
NR-Uu radio interface on the service link between the UE and the satellite
Satellite Radio Interface (SRI) on the feeder link between the NTN gateway and the satellite.

SRI (Satellite Radio Interface) is a transport link between NTN GW and satellite.

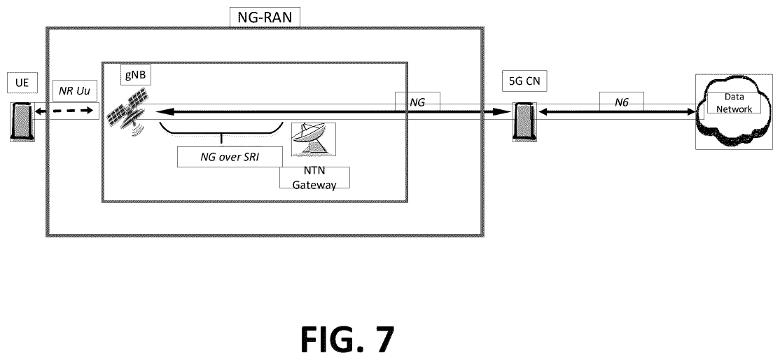

FIG. 7 is a reproduction of FIG. 5.2.1-1: Regenerative satellite without ISL, gNB processed payload, from 3GPP TR 38.821 V16.0.0.
NOTE: The satellite may embark additional traffic routing functions that are out of RAN scope.

The satellite payload also provides Inter-Satellite Links (ISL) between satellites ISL (Inter-Satellite Links) is a transport link between satellites. ISL may be a radio interface or an optical interface that may be 3GPP or non 3GPP defined but this is out of the study item scope.

The NTN GW is a Transport Network Layer node, and supports all necessary transport protocols.

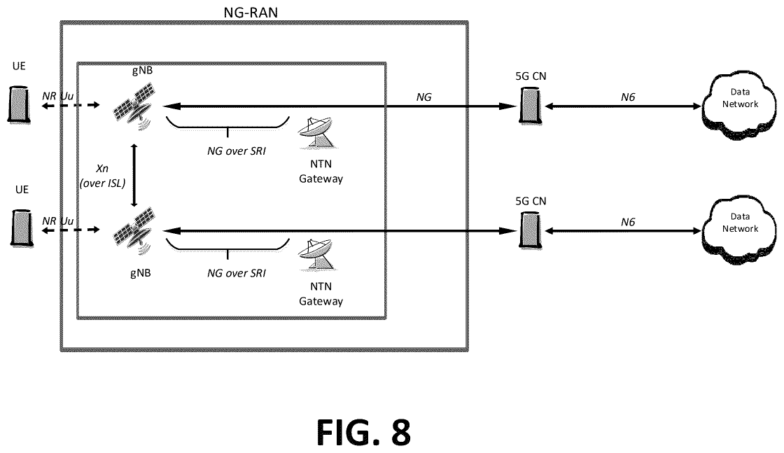

FIG. 8 is a reproduction of FIG. 5.2.1-2: Regenerative satellite with ISL, gNB processed payload, from 3GPP TR 38.821 V16.0.0.

The figure above illustrates that UE served by a gNB on board a satellite could access the 5GCN via ISL.

The gNB on board different satellites may be connected to the same 5GCN on the ground.

If the satellite hosts more than one gNB, the same SRI will transport all the corresponding NG interface instances.

[ . . . ]
5.2.2 gNB-DU Processed Payload

### 5.2.2.1 Overview

The NG-RAN logical architecture with CU/DU split as described in TS 38.401 is used as baseline for NTN scenarios.

The satellite payload implements regeneration of the signals received from Earth.
NR-Uu radio interface on the service link between the satellite and the UE
Satellite Radio Interface (SRI) on the feeder link between the NTN gateway and the satellite. The SRI transports the F1 protocol.

The satellite payload may provide inter-satellite links between satellites.

SRI (Satellite Radio Interface) are transport links; the logical interface F1 that they transport are 3GPP-specified.

The NTN GW is a Transport Network Layer node, and supports all necessary transport protocols.

DU on board different satellites may be connected to the same CU on ground.

If the satellite hosts more than one DU, the same SRI will transport all the corresponding F1 interface instances.

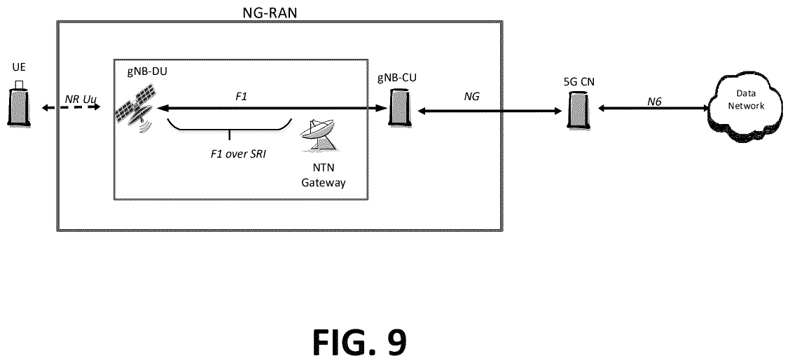

FIG. 9 is a reproduction of FIG. 5.2.2-1: NG-RAN with a regenerative satellite based on gNB-DU, from 3GPP TR 38.821 V16.0.0.

*************************************************************************************************

In 3GPP TR 22.865 ([2]3GPP TR 22.865 V2.0.0), Store & Forward (S&F) operation is introduced. The S&F is an operation mode of a 5G system with satellite-access where the 5G system can provide some level of service (in storing and forwarding the data) when satellite connectivity is intermittently/temporarily unavailable, e.g. to provide communication service for UEs under satellite coverage without a simultaneous active feeder link connection to the ground segment.

More details including use cases and potential requirements for S&F operation are also specified in [2]3GPP TR 22.865 V2.0.0:

### Annex A (Informative):

### Store and Forward Satellite Operation

The Store and Forward Satellite operation in a 5G system with satellite access is intended to provide some level of communication service for UEs under satellite coverage with intermittent/temporary satellite connectivity (e.g. when the satellite is not connected via a feeder link or via ISL to the ground network) for delay-tolerant communication service.

An example of “S&F Satellite operation” is illustrated in FIG. A-1, in contrast to what could be considered the current assumption for the “normal/default Satellite operation” of a 5G system with satellite access.

As shown in FIG. A-1:
Under “normal/default Satellite operation” mode, signalling and data traffic exchange between a UE with satellite access and the remote ground network requires the service and feeder links to be active simultaneously, so that, at the time that the UE interacts over the service link with the satellite, there is a continuous end-to-end connectivity path between the UE, the satellite and the ground network.
In contrast, under “S&F Satellite operation” mode, the end-to-end exchange of signalling/data traffic is now handled as a combination of two steps not concurrent in time (Step A and B in FIG. A-1). In Step A, signalling/data exchange between the UE and the satellite takes place, without the satellite being simultaneously connected to the ground network (i.e. the satellite is able to operate the service link without an active feeder link connection). In Step B, connectivity between the satellite and the ground network is established so that communication between the satellite and the ground network can take place. So, the satellite moves from being connected to the UE in step A to being connected to the ground network in step B.

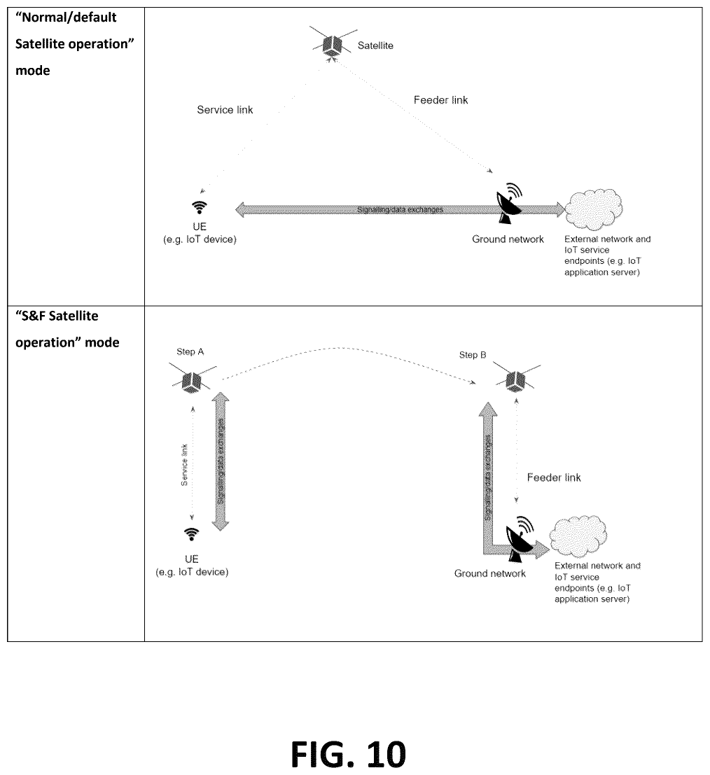

FIG. 10 is a reproduction of FIG. A-1: Illustration of “normal/default operation” and “S&F operation” modes in a 5G system with satellite access from 3GPP TR 22.865 V2.0.0.

The concept of “S&F” service is widely used in the fields of delay-tolerant networking and disruption-tolerant networking. In 3GPP context, a service that could be assimilated to an S&F service is SMS, for which there is no need to have an end-to-end connectivity between the end-points (e.g. an end-point can be a UE and the other an application server) but only between the end-points and the SMSC which acts as an intermediate node in charge of storing and relying.

The support of S&F Satellite operation is especially suited for the delivery of delay-tolerant/non-real-time IoT satellite services with NGSO satellites.

****************************************************************************************

In 3GPP TR 23.700-29 ([3]3GPP TR 23.700-29 V1.0.0), the key issue, candidate solutions, and conclusion for S&F are specified:

### 5.2 Key Issue #2: Support of Store and Forward Satellite Operation

### 5.2.1 Description

S&F Satellite operation is especially suited for the delivery of delay-tolerant/non-real-time satellite services (i.e. CIoT/MTC, SMS). To support S&F Satellite operation for such services, it is proposed to study the following items:
If applicable, what are the minimum necessary set of core network elements/network functions that should be placed on board the satellite(s) for the intended service(s);
Whether and how to trigger S&F Satellite operation, and how to execute S&F Satellite operation;
What enhancements on the related UE and network procedures are needed to support S&F Satellite operation, including:
   Whether to inform the UE when the S&F Satellite operation is applied or not.
NOTE 1: S&F for IoT NTN will be studied first and if there is remaining time available NR NTN can then be studied.
NOTE 2: Coordination with SA3-LI on LI aspects is needed.
NOTE 3: The candidate solutions need to indicate which service(s) they are addressing (CIoT CP Optimizations, CIoT UP Optimizations, SMS).
   [ . . . ]
   6.12 Solution #12: S&F for Multiple Satellite Deployment with Anchor MME-Ground

### 6.12.1 Description

For control plane management of registration and connection management procedures, we propose to have eNB and MME onboard the satellite.

Below are the principles of the solution:
1. MME-ground is an anchor node situated in ground network which has the UE context. MME-ground synchronizes the UE context with all the MME-onboard(s).
2. The eNB and MME-onboard are onboard the satellite. Thus they can provide basic connection management procedures. The MME-onboard executes all the procedures with the UE which does not need interaction with other core network nodes on the ground when the service link is available.
3. Whenever a procedure needs an interaction with a core network node in the ground then MME-onboard (stores it when feeder link is not available) and forwards the respective message to the MME-ground when feeder link is available, the MME-ground executes the procedure with the ground network nodes and syncs back the UE context with the MME-onboard or sends back the response message to the MME-onboard.
4. The MME-ground first receives information on any downlink signalling message, it forwards to MME-onboard (when feeder link is available), the MME-onboard can page the UE (when service link is available) and deliver respective message/execute the procedure with the UE.
5. To reduce number of iterations, if the MME-ground can be trusted then Authentication information and Subscription data fetching (i.e. update location and ack) is performed together before the UE can be authenticated. This is the decision of the HSS if such procedure should be allowed. If HSS does not allow such combining of the procedure to complete the attach procedure at least two iterations of interaction with ground network is required a) to fetch authentication vectors and b) to fetch subscription data after authentication procedure is executed in first iteration.
6. GUTI management, Periodic registration management, how UE identifies that it is allowed to register for S&F are described in procedures section.
7. Satellite-1, Satellite-2 are used as illustration in the flow. But the system can deploy “n” number of satellites for the same flow (or procedure).

### 6.12.2 Procedures

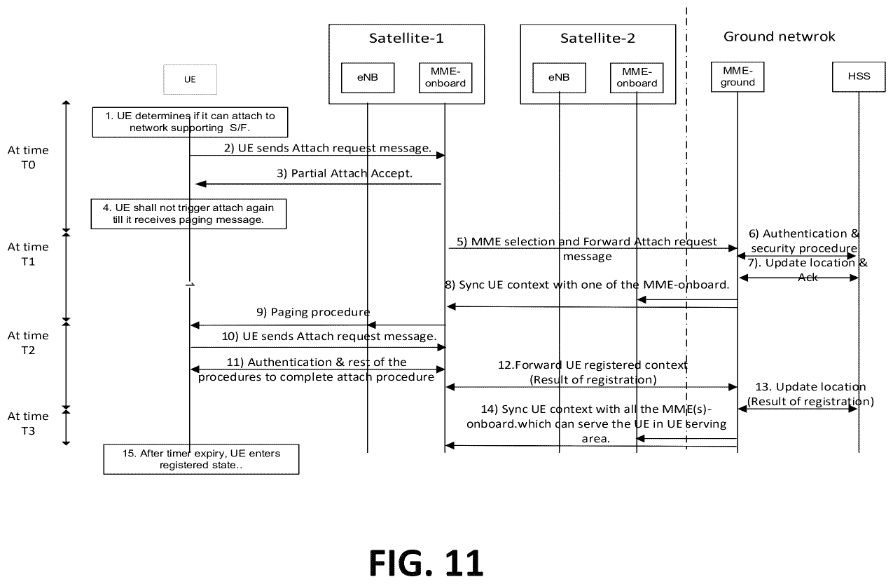

FIG. 11 is a reproduction of FIG. 6.12.2-1: Attach without PDN connectivity, from 3GPP TR 23.700-29 V1.0.0.

The eNB, MME-onboard are assumed to be onboard the satellite, there is a ground MME which is acting like an anchor for the MMEs onboard the satellite.

The attach procedure as described in clause 0.5.3.2.1 of TS 23.401 [5] are executed with below modifications.

At time T0 (i.e. when service link is available, and feeder link connectivity is not available).
1) In step 1, if the UE identifies that current serving cell support S&F mode and the UE is allowed to use S&F (see clause 6.12.3.1.2). then UE sends Attach Request message to network.
2) Steps up to step 4 in clause 0.5.3.2.1 of TS 23.401 [5] are executed between MME-onboard and the UE.
3) MME-onboard sends NAS message Partial attach accept (which can be unprotected) to the UE, indicating to the UE that the sent ATTACH REQUEST message is stored by the MME-onboard and network will reach UE once the UE authentication and subscription details are fetched by the MME-onboard from ground network. The Partial attach accept includes a temporary GUTI (though UE is not registered with network) and a wait timer till which UE should wait for network to send the paging message. The UE shall not select any other network which will provide store and forward service to the UE until the wait timer is running. The UE may select another network if available which can provide normal services to the UE while wait timer is running. The MME memorizes the UE serving area.
4) The UE receives Partial attach accept message. The UE shall not trigger Attach request again until paging message is received or wait timer is expired.
Editor's note: Security aspects of not performing authentication for steps 1-4 (e.g. denial of service attack, false BS attack) need to be resolved.

At time T1 (i.e. when service link is not available, and feeder link connectivity is available).
5) MME-onboard selects MME-ground (see clause 6.12.3.1.3). MME-onboard forward stored Attach request message, UE serving area to MME-ground.
6) Step 5 is executed between MME-ground and HSS, i.e. MME-ground fetches the authentication vector and other details from HSS.
7) Steps 8 & 11 are executed. i.e. Update location with HSS and Update location ACK is received by MME-ground. i.e. all the subscription details are retrieved by MME-ground. The MME indicates S&F to HSS to retrieve Subscription details specific to S&F (if any) and indicates that it is pre-fetching the subscription data without authenticating the UE.
8) The MME-ground syncs the UE information it retrieved with the MME-onboard. For optimization purpose, the MME-onboard can be any MME-onboard which will serve the UE next.

At time T2 (i.e. when service link is available, and feeder link connectivity is not available).
9) The MME-onboard when enters the UE serving area will page the UE with the assigned GUTI in Partial attach accept message.
10) The UE in response to receiving the paging message, the UE re-sends the Attach request message.

Editor's note: Recovery from failure to page the UE is FFS.
11) MME-onboard executes the step 5 of authentication and security procedure with the UE, once authentication procedure is successful then system executes remaining steps to complete Attach procedure with the UE. The MME-onboard also provide S&F policies to the UE which includes a UE context activation timer. The UE starts UE context activation timer after it receives the NAS message, the UE should consider itself registered with the network at the expiry of this timer. The MME based on subscription data available may send the reject message to the UE before or after the authentication/security procedure are executed.

At time T3 (i.e. when service link is not available, and feeder link connectivity is available).
12) MME-onboard indicates to MME-ground, if UE is successfully registered or registration procedure was not successful. MME-onboard syncs UE context with MME-ground if successful registration procedure is achieved.
13) MME-ground sends Update location indicating to HSS that UE is authenticated successfully or not authenticated successfully, which implies to HSS that subscription data is not required in response.
14) If UE context is created or changed in any of the MME-onboard, this will be synced with all the MME-onboard(s) when they connect with ground network. Deployment should handle that this sync of UE context with all satellites should not take more time than UE context activation timer.
Editor's note: After change to the UE context in an MME-onboard, the UE must wait until the new UE context is transferred to other satellites before again accessing a satellite. How this can be managed is FFS.
15) After expiry of UE context activation timer the UE enters EMM-REGISTERED state.

### 6.12.2.1.1 Periodic Timer and Mobile Reachable Timer

The Mobile Reachable Timer (MRT) is run only at the MME-ground, each time UE gets in connected mode with any of the MME-onboard, the MME-onboard informs the MME-ground, then MME-ground restart the MRT timer.

The mobile reachable timer value has to be increased at network so that it takes into account delay in receiving information from the MME-onboard after UE has come to connected mode(including case of PTAU procedure).

For e.g. Mobile reachable timer=PTAU timer given to UE+Maximum potential delay for MME-onboard to connect with MME-ground after UE has come to connected mode (including case of PTAU procedure).

Each MME-onboard runs a MME-UE-context onboard timer, at expiry of this timer, the MME-onboard synchronizes the UE context with MME-ground.

6.12.2.1.2 How UE Identifies that it is Allowed to Attach with Network for S/F

If UE determines that it has no other network which can provide normal services then UE may determine to attach in store and forward mode. Similar to CAG mechanism available in 5GS, we propose that UE is configured with S&F information and if configured S&F ID is broadcasted along with the indication of support for S/F mode (i.e. feeder link is not available) then UE will attach with the network in S&F mode. If the UE is not configured with S&F ID and the serving network broadcasts support of S&F (i.e. feeder link is not available) then UE may attempt attach to register and receive allowed S&F IDs from network.

### 6.12.2.1.3 GUTI Management and MME Selection

The GUTI is assigned to the UE only by the MME-ground which is stored commonly with all the MME(s)-onboard in the UE context. The eNB-onboard selects the MME-onboard:
a) Based on the MME-group ID which can be kept common for all the MME(s)-onboard which can serve the UE based on UE serving area and the MME-ground; or
b) Following range of MME IDs which are expected to be same for selection. i.e. if eNB receives one MME-ID(during RRC connection establishment) it can select any of the MMEs it has connection from the range of MME IDs;
c) The eNB will follow current mechanism to select MME-onboard, it may take into account S&F indication in the RRC signalling procedure.

### 6.12.2.1.4 MME-Ground Selection by MME-Onboard

MME-onboard selects the MME-ground when UE first attaches the network.

MME-onboard should follow same selection mechanism as eNB selects MME in Rel-18 to select a MME-ground.

The MME-onboard is assume to support all the features MME-ground supports.

MME-ground once assigns the GUTI, MME-onboard can uniquely identify the MME-ground, MME-onboard is configured with all ground station IDs which MME-onboard can connect to reach MME-ground. This information is provided to all MME(s)-onboard during the UE attach procedure and successful UE context is synchronized. MME-ground is configured with potential MME-onboard(s) which can serve the UE based on the UE serving area. The MME-ground is locally configured with this information or can be configured by O&M or AF (through SCEF path).

### 6.12.2.1.5 Authentication Procedure/Subscription Details Fetch During any Other Procedure

If network determines to execute authentication procedure/fetch subscription details etc during any time for e.g. during service request procedure execution then the concept of partial attach accept discussed above is applicable. i.e. UE is indicated in NAS message that network has stored uplink message and network will get back to the UE once UE authentication/subscription details are fetched from ground network.

6.12.2.1.6 Attach with PDN Connectivity, Multiple Satellite

The gNB, MME, S-GW and P-GW are assumed to be onboard the satellite.

Assumption-1: If we assume there is no need for PCRF because PCC policies can be configured in the P-GW onboard satellite because. communication is for delay tolerant devices there is no specific or very small policies may need to be applied.

Assumption-2: In case of dynamic PCC deployment is required then PCRF also is assumed to be on board the satellite.

Then is no changes are expected on top of above flow. Because P-GW/S-GW/PCRF are available for interactions with MME onboard the satellite to establish the PDN connections

Similar to MME-ground, there is a P-GW-ground, S-GW-ground to sync with the UE context.
Editor's note: Any other enhancements required to handle data transfer or onboard core network entities is FFS.

### 6.12.3 Impacts on Services, Entities and Interfaces

a) MME-ground is an anchor node situated in ground network which has the UE context. MME-ground synchronizes the UE context with all the MME-onboard(s).
b) The eNB and MME-onboard are onboard the satellite. Thus they can provide basic connection management procedures with the UE. The MME-onboard executes all the procedures with the UE which does not need interaction with other core network nodes on the ground when the service link is available.
c) Whenever a procedure needs an interaction with a core network node in the ground then MME-onboard(stores it when feeder link is not available) and forwards the respective message to the MME-ground when feeder link is available, the MME-ground executes the procedure with the ground network nodes and syncs back the UE context with the MME-onboard or sends back the response message to the MME-onboard.
d) GUTI management, Periodic registration management, how UE identifies that it is allowed to register for S&F are described in the procedures clause.
   [ . . . ]

### 8.2 Conclusion for KI #2: Support of Store and Forward Satellite Operation

NOTE 1: Whether to have a full CN onboard the satellite or Split MME architecture is up to the operation deployment.
NOTE 2: The security issues (if any) of these conclusions are in the scope of SA WG3.
NOTE 3: The LI issues (if any) of these conclusions are in the scope SA WG3-LI.
NOTE 4: The deployments are subject to regulatory requirements.

The following option is agreed for supporting Store and Forward operation with a Split MME architecture with the following (informative) principles:
1) In the Split MME architecture, HSS is on the ground.
2) MME functionality is split into two parts: MME-onboard—the MME part which is onboard the satellite and MME-ground—the MME part which is on the ground network with an interface out of scope of 3GPP.
3) The MO data is stored in the MME-onboard when the service link is available and the feeder link is unavailable, and transferred to the ground when the feeder link becomes available. The MT data is stored in the MME-ground or in S-GW when the feeder link is unavailable and transferred to the MME-onboard when the feeder link becomes available. The MT data is stored in the MME-onboard when the feeder link is available and service link is unavailable, and transferred to the UE when service link becomes available. All types of data traffic (e.g. IP, etc.) can be supported and transferred using the existing user plane and control plane procedures defined in EPS.
4) For MO SMS, upon reception of the MO SMS the MME-onboard stores the MO-SMS and may immediately send the delivery report(i.e. RP-ACK) to the UE i.e. as if the MO-SMS has already been successfully delivered to the Service Centre (SC).

With the following normative impacts:
1) When feeder link is not available and the network supports S&F operation, the network shall be able to inform UE(s) whether S&F Satellite operation is applied, (e.g. eNB broadcast support of S&F operation as part of System Information).
NOTE 1: The trigger for the eNB to broadcast support of S&F operation is based on the decision of RAN WGs. From system perspective the expectation is that if the network does not support S&F operation and the feeder link is not available then eNB switches off and does not broadcast any signal.
2) When UE initiates Attach or TAU procedure, it indicates support for S&F mode to the MME following existing NAS capability, the MME sends Attach or TAU Reject message to the UE if these procedures cannot be completed due to S&F operation. The Attach or TAU Reject message includes:
   a) A new information indicating the UE that attach or TAU procedure cannot be completed because of the S&F operation and that the UE can re-attempt the attach or TAU in this PLMN in a next satellite pass. This indicates to the UE that the information contained in the Attach or TAU Request message is stored by the MME and the network will be available to the UE after interaction with ground network.
   b) Wait timer: Indicates to the UE the time it should wait before re-attempting the Attach/TAU procedure in the current or another satellite of the same PLMN.
   c) Optionally, The list of Satellite IDs over which the UE may re-attempt the Attach/TAU procedure, after wait timer expires. The Satellite IDs are based on the SIB information broadcasted by eNB.
3) How the UE process this information is up to UE implementation and during the wait timer the UE can search for another terrestrial or satellite PLMN to get normal service.
4) MME may indicate to HSS the “Request Time”, allowing the HSS to check that no other (e.g. terrestrial) MME has sent an Update Location Request after the “Request Time”, and fetches the authentication vector and other details from HSS following current Authentication and security procedures. The MME may triggers Update location with the HSS and Update location ACK is received by MME. i.e. all the subscription details are retrieved by MME-ground. The Update Location Request includes an indication that this location update is provisional i.e. the HSS must not consider the UE as registered until it receives the final Update Location Request.
5) When the wait timer has expired given to the UE in step 2, if the UE has not successfully attached to another PLMN and the UE finds the cell which broadcast the Satellite ID valid to re-attempt the attach procedure, the UE re-sends the Attach or TAU Request message.
6) During the Attach or TAU procedure with the UE, the MME may also provide a list of Satellite IDs over which the UE may exchange the signalling and data, and a wait-timer that indicates to the UE the time it should wait before attempting signalling and data exchanges in those satellites.
7) The MME may indicate to UE the estimated delivery time in NAS messages (Attach accept or TAU accept message or service accept). How UE uses this information is left for UE implementation.
NOTE 2: The estimated delivery time is the estimated time to send data from the UE to Gateway.
8) The core network can indicate to external SCS/AS whether UE is registered in S&F Mode and the estimated delivery time.
NOTE 3: Whether any existing monitoring events or procedures can be used or enhanced to achieve above will be determined during normative phase.
NOTE 4: SA WG2 will align further based on agreements in SA WG3 e.g. on security procedures and Attach/TAU procedures.

The split MME architecture will be described in informative annex.

The following option is agreed for supporting Store and Forward operation with a full CN onboard the satellite with the following (informative) principles:
The whole CN including eNB, MME, SGW, PGW, HSS, E-SMLC, SMSC etc are on board each satellite. Proxies are deployed on the satellite and the ground for application traffic, including support of MT traffic, MO traffic, SMS, etc.
The implementation of the proxies and the interface between them is out of 3GPP scope.
The UE attaches, transfers data (e.g. SMS, MO and MT data, etc.) and detaches from each satellite as required and as determined by the monitoring list.
NOTE 5: MT traffic is delivered to the UE after it performs an ATTACH.
NOTE 6: After mobility from S&F operation, MT traffic could be stuck in the ground proxy and will only be retrieved once the UE goes back to S&F operation.

For MT traffic, the UE attaches to a satellite and to allow delivery of MO traffic from the user or applications on the UE. A UE, based on implementation, could first wait for an indication from the user or from an application on the UE of pending MT traffic or could wait based on knowledge of when MT traffic may arrive, before performing the attach.
Depending on the deployment and implementation (i.e. outside the scope of 3GPP in this release), the HSSs on the satellites may be populated with subscription data either for only the UEs that may access satellite or all UEs that may access the satellite.
Depending on the deployment, the UE may have a USIM enhanced for IOPS, or a USIM dedicated to the satellite network.
NOTE 7: The solution does not support the roaming architectures defined in TS 23.501 [2] or TS 23.401 [5].

With the following normative impacts:
Store and forward is only supported by EPS.
Optionally the MME provides the UE with a S&F monitoring list of satellites IDs, during attach/TAU. The UE uses the satellites in the S&F monitoring list for MO/MT data/signalling with the CN. The S&F monitoring list can be determination by the CN. How network determines the S&F monitoring list is outside the scope of 3GPP in this release of specification.
NOTE 8: The S&F monitoring list may assist the UE in retrieving MT data.
The UE needs to be aware that a satellite supports S&F mode.
NOTE 9: How the UE is aware that a satellite supports S&F mode of operation depends on RAN.
A UE may be rejected if the satellite cannot support the UE at this time. The attach reject may provide a timer for the time the UE should wait before reattempting and S&F monitoring list which the UE can attempt attach again.
   ****************************************************************************************

A Non-Terrestrial Network (NTN) may be viewed as a network which provides non-terrestrial access to User Equipment (UE(s)), e.g., by means of an NTN payload embarked on an airborne or space-borne NTN vehicle and an NTN Gateway. NTN may comprise one or more network nodes such as a Next Generation Radio Access Network (NG-RAN) node or a Next Generation Node B (gNB). The UE may link to, camp on, and/or connect to the NTN network for transmission and/or reception.

The NTN may comprise various platforms, including low earth orbit (LEO) satellite, medium earth orbit (MEO) satellite, highly elliptical orbit (HEO) satellite, geostationary earth orbit (GEO) satellite, geostationary synchronous Orbit (GSO) satellite, non-geostationary synchronous orbit (NGSO) satellite, and/or high altitude platform station (HAPS). A LEO satellite could have an earth-fixed beam (e.g., the beam is temporarily fixed on a location during a time period) or an earth-moving beam (e.g., the beam is continuously moving along with the satellite). A LEO satellite could serve/provide earth moving cells (e.g., with an earth-fixed beam) and/or (quasi-)earth fixed cells (e.g., with an earth-moving beam).

The NTN could offer a wide-area coverage and provide Network (NW) access in the scenario when Terrestrial Networks (TNs) are unfeasible (e.g., desert, polar area, and/or on an airplane). More details regarding different NTN platforms could be found in [1] 3GPP TR 38.821 V16.0.0.

A Store and Forward (S&F) operation could be considered as an operation mode of satellite-access providing some level of service (in storing and forwarding the data) when satellite connectivity is intermittently/temporarily unavailable, e.g., to provide communication service for UEs under satellite coverage without a simultaneous active feeder link connection to the ground segment.

The network supporting S&F operation may be based on an architecture of regenerative payload (e.g., as specified in [1] 3GPP TR 38.821 V16.0.0). The network may comprise a Radio Access Network (RAN) and/or a Core Network (CN). The RAN may comprise one or more RAN node(s). The CN may comprise one or more CN node(s). The RAN (or RAN node) may be (or comprise) an NG-RAN node, gNB, gNB-Distributed Unit (DU), gNB-Central Unit (CU), Evolved Universal Terrestrial Radio Access Network (E-UTRAN) node, Evolved Node B (eNB), and/or a base station. The CN (or CN node) may be (or comprise) an Evolved Packet Core (EPC), Mobility Management Entity (MME), Serving Gateway (S-GW), 5G Core (5GC), User Plane Function (UPF), Access and Mobility Management Function (AMF), Session Management Function (SMF), Home Subscriber Server (HSS), and/or a network node specified in TS 23.501 ([5]3GPP TS 23.501 V18.1.0).

The network (e.g., 5G system) may be separated into (at least) two parts. One part of the network, comprising one or more network node(s) or network segment(s), is located on a satellite. The other part of the network, comprising one or more network node(s) or network segment(s), which is not located on a satellite, is located on the ground. The network node(s) and/or network segment(s) may be one or more network nodes (e.g., RAN node or CN node) and/or a portion and/or a combination of the network node(s) mentioned or not mentioned above. For simplicity, the network, network node(s), and/or network segment(s) located in a satellite (or the related network as mentioned above) may be referred as an NW on satellite (or satellite NW). The network, network node(s), and/or network segment(s) located on the ground (or the related network as mentioned above) may be referred as an NW on ground (or ground NW).

For example, the satellite NW may be (or comprise) RAN (e.g., NG-RAN, gNB, and/or eNB). The ground NW may be (or comprise) CN (e.g., EPC, 5GC, MME, S-GW, AMF, and/or UPF). For example, the satellite NW may be (or comprise) gNB-DU. The ground NW may be (or comprise) gNB-CU and/or one or more CN nodes (e.g., AMF, UPF). For example, the satellite NW may be (or comprise) RAN (e.g., NG-RAN, gNB, and/or eNB) and/or one or more CN nodes (or segment) (e.g., AMF, UPF, MME, S-GW). The ground NW may be the another/other one or more CN nodes (or segment) (e.g., excluding the part of the satellite NW).

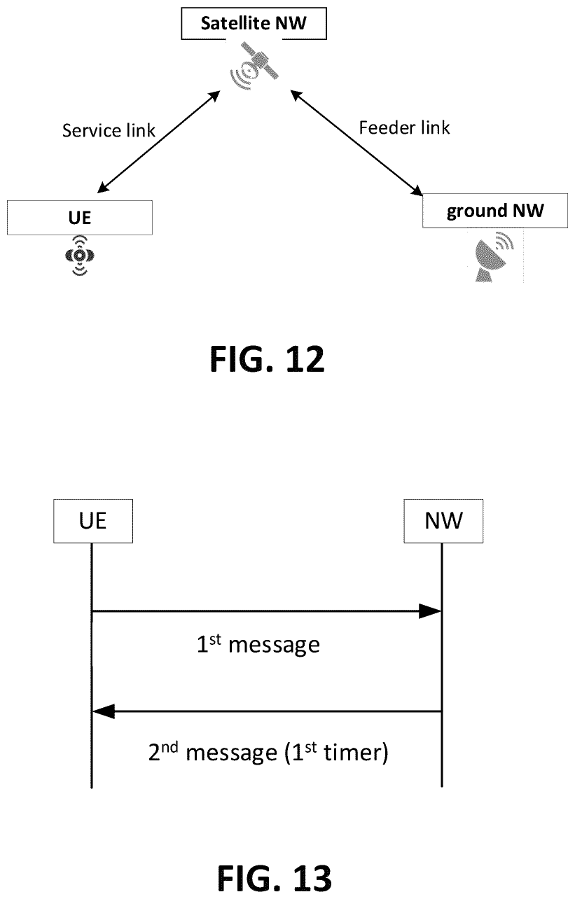

The link/connection/interface between the satellite NW and the ground NW may be referred as a feeder link. The link/connection/interface between the satellite NW and the UE may be referred as a service link. An example is shown in FIG. 12.

Based on the candidate solution(s) and/or the conclusion of S&F specified in [3] 3GPP TR 23.700-29 V1.0.0, when (or in response to) a UE initiates an attach or tracking area update (TAU) procedure (e.g., for S&F) and/or transmits an attach request or TAU request, the UE may receive a response message including a configuration of a wait time (or wait timer). The UE may start a wait timer based on the configuration. When the wait timer is running, the UE should not attempt to access the (same) network (at least for S&F). When the wait timer is running, the UE could search for another Public Land Mobile Network (PLMN) (e.g., to get normal service). When the wait timer is expired, if the UE has not successfully attached to another PLMN, the UE should re-attempt the attach or TAU procedure and/or (re)transmit the attach request or TAU request (e.g., for S&F).

However, if the UE determines whether it has successfully attached to another PLMN upon expiry (expiration) of the wait timer, it may be possible that the UE has found another PLMN and has initiated an Attach/TAU procedure (e.g., for normal service) while the procedure has not successfully completed when the wait timer is expired. The procedure may be ongoing upon expiry of the wait timer. In this case, it is not appropriate to immediately re-attempt the attach or TAU procedure with the original network (e.g., for S&F).

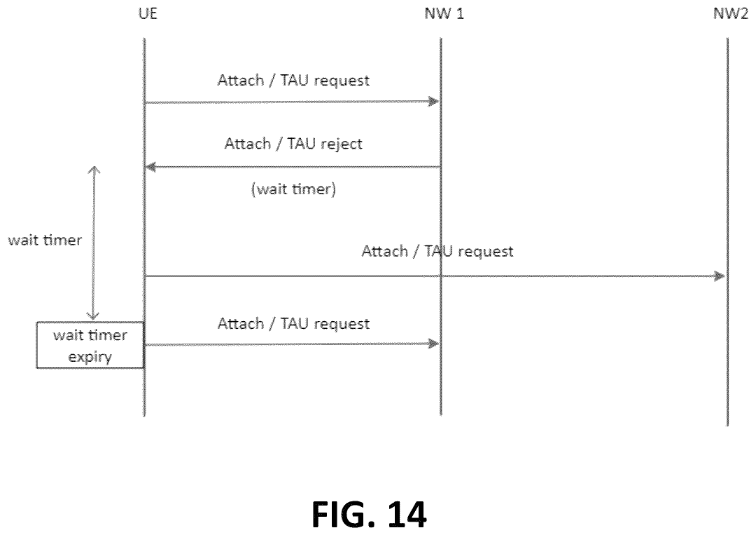

Re-attempting the attach or TAU procedure with the original network (e.g., for S&F) may not be optimal since the UE may lose the chance to get normal service. An example of the issue is shown in FIG. 14. Moreover, the UE may find a cell in the same PLMN which provides normal service when the wait timer is running, and it is also not optimal to re-attempt the original network (e.g., for S&F) if the found cell could provide normal service.

To at least solve the issue, at least one or more of the method(s), aspect(s), embodiments(s), and concept(s) described below may be considered.

A UE may initiate a first procedure (e.g., to a first network). The first procedure may be for S&F operation. The first procedure may be (or comprise) an attach procedure. The first procedure may be (or comprise) a TAU (tracking area update) procedure. The first procedure may be (or comprise) a registration procedure. The first procedure may be (or comprise) a service request procedure. An example of the first procedure is shown in FIG. 13.

The UE may transmit a first message (e.g., a request message) to a network (e.g., the first network), e.g., during the first procedure. The first message may (at least) indicate that the UE supports S&F operation. The first message may (at least) indicate that the UE requests S&F operation. The first message may (at least) indicate a request in S&F operation. The first message may be (or comprise) a request message of the first procedure. The first message may be (or comprise) an attach request. The first message may be (or comprise) a TAU request. The first message may be (or comprise) a registration request. The first message may be (or comprise) a service request.

The UE may receive a second message (e.g., a response message) from a network (e.g., the first network), e.g., during the first procedure, in response to transmitting the first message. The second message may (at least) indicate that the network supports S&F operation. The second message may (at least) indicate that the network enables (or activates/starts) S&F operation. The second message may (at least) indicate that the first message is stored at the (satellite) network, and/or the first message is to be transmitted (or forwarded) to a ground network later (e.g., when a feeder link is available). The second message may (at least) indicate that the network will respond to the UE later (e.g., after the network fetches a response from a ground network). The second message may be (or comprise) an accept message. The second message may be (or comprise) a reject message. The second message may be (or comprise) a partial accept message. The second message may be (or comprise) a partial reject message.

A (configuration of) wait time may be included in the second message. The wait time may indicate how long the UE should wait for the network to respond (e.g., paging from the network). The wait time may indicate how long the UE is prohibited to trigger (or initiate) the first procedure (and/or transmit the first message) to the network (e.g., the first network) again (e.g., for S&F). The wait time may be (or comprise) a time duration (or period). The wait time may be a time reference (or time point).

The UE may start a first timer (e.g., a wait timer) based on the wait time. The first timer may be started with a value set to the wait time. The first timer may be started in response to receiving the (configuration of) wait time (and/or the second message). The first timer may be a wait timer. The first timer may be a Non-Access Stratum (NAS) timer. The first timer may be used for S&F operation. The first timer may be used to control when the UE should retry the first procedure. The first timer may be used to control how long the UE should wait before retrying the first procedure.

When the first timer is running, the UE may be prohibited (or not allowed) to initiate (or trigger) the first procedure (and/or transmit the first message) to the (same) network (e.g., for S&F). When the first timer is running, the UE may be prohibited (or not allowed) to select another network (e.g., a second network) for S&F operation. When the first timer is running, the UE may be allowed to select another network for normal service.

A list of satellite Identifications (ID(s)) may be included in the second message (e.g., along with the wait time). The list of satellite ID(s) may indicate the satellite(s) over which the UE may re-attempt the first procedure (and/or retransmit the first message) after (or upon/when/if/in response to) expiry of the first timer. The list of satellite ID(s) may indicate the satellite(s) over which the UE may not re-attempt the first procedure (and/or retransmit the first message) when the first timer is running. The list of satellite ID(s) may indicate the satellite(s) over which the UE may exchange data or signaling restricted by the first timer.

When (or upon/if/after/in response to) the first timer expires, the UE may initiate (or trigger) the first procedure (and/or transmit the first message) again to the network (e.g., the first network), e.g., for S&F operation. When (or upon/if/after/in response to) the first timer expires, the UE may be allowed to initiate (or trigger) the first procedure (and/or transmit the first message) again to the network (e.g., the first network), e.g., for S&F operation.

The UE may be capable of using S&F operation. The network may be capable of providing S&F operation.

When the first timer is running, the UE may initiate a second procedure (e.g., to a second network). The UE may initiate the second procedure in response to (or when/upon/if/due to) the UE (determines to) (re)select (or connect to/attach to/register to/subscribe a service to) another network (e.g., the second network), e.g., for normal service.

The second procedure may be for normal service. The second procedure may be the same as the first procedure. The second procedure may be different from the first procedure. The second procedure may be (or comprise) an attach procedure. The second procedure may be (or comprise) a TAU procedure. The second procedure may be (or comprise) a registration procedure. The second procedure may be (or comprise) a service request procedure.

The UE may transmit a third message (e.g., a request message) to a network (e.g., the second network), e.g., during the second procedure. The third message may (at least) indicate that the UE requests normal service (e.g., other than S&F operation). The third message may (at least) indicate a request in normal service (e.g., other than S&F operation). The third message may be (or comprise) a request message of the second procedure. The third message may be (or comprise) an attach request. The third message may be (or comprise) a TAU request. The third message may be (or comprise) a registration request. The third message may be (or comprise) a service request.

The UE may receive a fourth message (e.g., a response message) from a network (e.g., the second network), e.g., during the second procedure, in response to transmitting the third message. The fourth message may (at least) indicate that the network enables (or activates/starts) normal service (e.g., other than S&F operation). The fourth message may be (or comprise) an accept message. The fourth message may be (or comprise) a reject message.

The UE may stop the first timer when (or upon/if/in response to) the UE (determines to) (re)select (or connect to/attach to/register to/subscribe a service to) another network (e.g., the second network), e.g., if (at least) the first timer is running.

The UE may stop the first timer when (or upon/if/in response to) the UE initiates the second procedure, e.g., if (at least) the first timer is running.

The UE may stop the first timer when (or upon/if/in response to) the UE transmits the third message, e.g., if (at least) the first timer is running.

The UE may stop the first timer when (or upon/if/in response to) the UE receives the fourth message, e.g., if (at least) the first timer is running.

The UE may stop the first timer when (or upon/if/in response to) the UE completes (or terminates) the second procedure, if (at least) the first timer is running. The second procedure may be completed (or terminated) successfully. The second procedure may be completed (or terminated) unsuccessfully.

The UE may stop the first timer when (or upon/if/in response to) the UE successfully performs or completes the second procedure, if (at least) the first timer is running.

The UE may stop the first timer when (or upon/if/in response to) the UE cancels (or aborts) the second procedure, e.g., if (at least) the first timer is running.

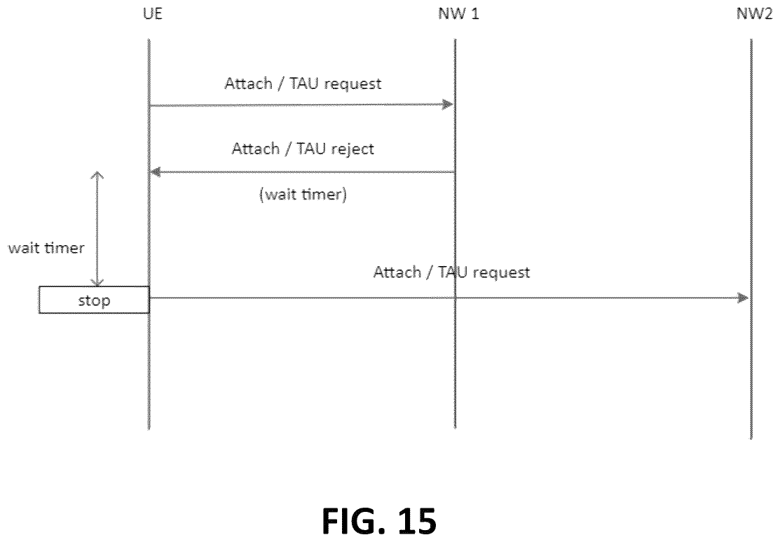

An example of the solution is shown in FIG. 15.

The UE may suspend the first timer when (or upon/if/in response to) the UE (determines to) (re)select (or connect to/attach to/register to/subscribe a service to) another network (e.g., the second network), e.g., if (at least) the first timer is running.

The UE may suspend the first timer when (or upon/if/in response to) the UE initiates the second procedure, e.g., if (at least) the first timer is running.

The UE may suspend the first timer when (or upon/if/in response to) the UE transmits the third message, e.g., if (at least) the first timer is running.

The UE may suspend the first timer when (or upon/if/in response to) the UE receives the fourth message, e.g., if (at least) the first timer is running.

The UE may suspend the first timer when (or upon/if/in response to) the UE completes (or terminates) the second procedure, e.g., if (at least) the first timer is running. The second procedure may be completed (or terminated) successfully. The second procedure may be completed (or terminated) unsuccessfully.

The UE may suspend the first timer when (or upon/if/in response to) the UE cancels (or aborts) the second procedure, e.g., if (at least) the first timer is running.

The UE may suspend the first timer before the UE initiates the second procedure, e.g., if (at least) the first timer is running.

The UE may resume the first timer when (or upon/if/in response to) the UE (determines to) (re)select (or connect to/attach to/register to/subscribe a service to) another network (e.g., the second network), e.g., if (at least) the first timer is suspended.

The UE may resume the first timer when (or upon/if/in response to) the UE transmits the third message, e.g., if (at least) the first timer is suspended.

The UE may resume the first timer when (or upon/if/in response to) the UE receives the fourth message, e.g., if (at least) the first timer is suspended.

The UE may resume the first timer when (or upon/if/in response to) the UE initiates the second procedure, e.g., if (at least) the first timer is suspended.

The UE may resume the first timer when (or upon/if/in response to) the UE completes (or terminates) the second procedure, e.g., if (at least) the first timer is suspended. The second procedure may be completed (or terminated) successfully. The second procedure may be completed (or terminated) unsuccessfully.

The UE may resume the first timer when (or upon/if/in response to) the UE cancels (or aborts) the second procedure, e.g., if (at least) the first timer is suspended.

The UE may start (or restart) the first timer when (or upon/if/in response to) the UE (determines to) (re)select (or connect to/attach to/register to/subscribe a service to) another network (e.g., the second network).

The UE may start (or restart) the first timer when (or upon/if/in response to) the UE initiates the second procedure.

The UE may start (or restart) the first timer when (or upon/if/in response to) the UE transmits the third message.

The UE may start (or restart) the first timer when (or upon/if/in response to) the UE receives the fourth message, e.g., if the first timer is stopped due to the second procedure.

The UE may start (or restart) the first timer when (or upon/if/in response to) the UE completes (or terminates) the second procedure, e.g., if the first timer is stopped due to the second procedure. The second procedure may be completed (or terminated) successfully. The second procedure may be completed (or terminated) unsuccessfully.

The UE may start (or restart) the first timer when (or upon/if/in response to) the UE cancels (or aborts) the second procedure, e.g., if the first timer is stopped due to the second procedure.

The UE may perform at least a first action(s) upon (or when/if/in response) expiry of the first timer.

The UE may perform at least the first action(s) if (at least) the second procedure is not ongoing.

The UE may not perform at least the first action(s) during the second procedure, e.g., upon expiry of the first timer, when the first timer is not running. The UE may not perform at least the first action(s) if (at least) the first timer expires during the second procedure, e.g., upon expiry of the first timer, when the first timer is not running.

The UE may determine (whether) to perform at least the first action(s) (e.g., upon expiry of the first timer, when the first timer is not running) based on (at least) whether the second procedure is ongoing (or not).

The UE may perform at least the first action(s) upon (or when/if/in response to) the second procedure is completed (or terminated, or cancelled), e.g., if (at least) the first timer expires during the second procedure. The second procedure may be completed (or terminated) successfully. The second procedure may be completed (or terminated) unsuccessfully.

The UE may consider the first timer as expired at the end of the second procedure, e.g., if the first timer expires during the second procedure.

The UE may consider the first timer as expired upon (or when/if/in response to) the second procedure is completed (or terminated, or cancelled), e.g., if the first timer expires during the second procedure. The second procedure may be completed (or terminated) successfully. The second procedure may be completed (or terminated) unsuccessfully.

The UE may perform at least the first action(s) upon (or when/if/in response to) the UE receives the fourth message, e.g., if the first timer expires during the second procedure.

The first action(s) may be (or comprise) one or more of the following:
Initiate (or re-initiate) the first procedure (e.g., for S&F operation, or via the first network),
Transmit (or retransmit) the first message (e.g., for S&F operation, or via the first network),
Allow (or enable) the UE to (re)select (or connect, or attach, or register, or subscribe service) to network (e.g., the first network), and/or
Allow (or enable) the UE to continue (or resume) the first procedure (e.g., for S&F operation, or via the first network).

When the first timer is running, the UE may be prohibited (or not allowed) to initiate (or trigger) the first procedure (and/or transmit the first message), e.g., to the first network, and/or for S&F operation. When the first timer is running, the UE may be prohibited (or not allowed) to (re)select (or connect, or attach, or register, or subscribe service) to a network, e.g., the second network, and/or for S&F operation. The prohibition may be applied to the network indicated by the list of satellite ID(s). The prohibition may not be applied to the network not indicated by the list of satellite ID(s).

When the first timer is running, the UE may be allowed (or may not be prohibited) to initiate (or trigger) the second procedure (and/or transmit the third message), e.g., to the second network, and/or for normal service (e.g., other than S&F operation). When the first timer is running, the UE may be allowed (or may not be prohibited) to (re)select (or connect, or attach, or register, or subscribe service) to a network, e.g., the second network, and/or for normal service (e.g., other than S&F operation).

When the first timer is not running, the UE may be allowed to initiate (or trigger) the first procedure (and/or transmit the first message), e.g., to the first network, and/or for S&F operation. When the first timer is not running, the UE may be allowed to (re)select (or connect, or attach, or register, or subscribe service) to a network, e.g., the second network, and/or for S&F operation.

The network (e.g., the first network, the second network) may be (or comprise) a PLMN.

The network (e.g., the first network, the second network) may be (or comprise) a satellite NW.

The network (e.g., the first network, the second network) may be (or comprise) an NTN.

The network (e.g., the first network, the second network) may be (or comprise) a TN.

The network (e.g., the first network, the second network) may be (or comprise) a cell.

The network (e.g., the first network, the second network) may be (or comprise) a group of cells.

The first network and the second network may be of different network types (e.g., TN, NTN).

The first network and the second network may be of different PLMNs.

The first network is a first PLMN and/or the second network is a second PLMN.

The first network and the second network may be of different cells.

The first network and the second network may provide different types of services (e.g., S&F operation, normal service).

The first network and the second network may be of the same PLMN.

The first network may be (or comprise) an S&F satellite network (e.g., E-UTRAN).

The second network may be (or comprise) other than the first network.

The second network may be (or comprise) a non-S&F satellite network (e.g., E-UTRAN).

The second network may be (or comprise) a terrestrial network (e.g., E-UTRAN).

The first network may be (or comprise) a network (or network node) indicated by (or inside) the list of satellite ID(s).

The second network may be (or comprise) a network (or network node) not indicated by (or outside) the list of satellite ID(s).

The first procedure and/or the second procedure may be (or comprise): a registration (or deregistration) procedure, attach procedure, tracking area update procedure, Protocol Data Unit (PDU) session establishment (or modification) procedure, NAS transport procedure, Packet Data Network (PDN) connectivity procedure, and/or a service request procedure.

The first procedure and/or the second procedure may be (or comprise): a Radio Resource Control (RRC) connection establishment procedure, RRC connection re-establishment procedure, and/or an RRC connection resume procedure.

The first procedure may be for S&F operation, for non-S&F operation, or for normal service.

The second procedure may be for S&F operation, for non-S&F operation, or for normal service.

The first network may be initially operated in S&F and/or provide S&F service. The first network may provide (or broadcast) an indication of S&F operation, e.g., in system information. The indication may indicate that the first network is in S&F mode, using S&F operation, and/or providing S&F service. The UE may receive a configuration of the wait time (or the first timer) from the first network, e.g., in the second message, during the first procedure, and/or while the first network is under S&F operation.

In some situation(s), it may be possible that the first network may change (or switch) an operation mode, e.g., leaving S&F mode, disabling S&F operation, enabling normal service, and/or entering default mode (or normal mode). The change may be due to a feeder link of the first network becomes available. The first network may stop providing (or stop broadcasting) the indication of S&F operation, e.g., in system information. The first network may indicate that it is in default mode, using normal operation, and/or providing normal service (e.g., by the absence or disabling of the indication).

When (or if/upon/in response to) the UE detects at least a first condition(s), the UE may stop the first timer, e.g., if (at least) the first timer is running.

The first condition(s) may be (or comprise) one or more of the following:
The first network changes (or switches) an operation mode (e.g., from S&F mode to default/normal mode),
The first network disables S&F operation, stop providing S&F service, and/or leaves S&F mode,
The first network enables normal operation, start providing normal service, and/or enter default mode (or normal mode),
The first network stops providing an indication of S&F mode (e.g., in system information), and/or
The first network changes a value of the indication of S&F mode (e.g., from enable to disable).

The operation mode may include: S&F mode/operation/service, normal (or default) mode/operation/service.

Throughout the present disclosure. the following terms may be interchangeable: S&F, S&F mode, S&F operation, S&F service.

Throughout the present disclosure. the following terms may be interchangeable: normal mode, default mode, normal service, normal operation.

A UE and/or a network (e.g., a network node) may be in S&F mode (or use S&F operation) if at least one or more of the following conditions are fulfilled:
The feeder link (of the UE and/or the network or network node) is not available,
An indication of S&F mode (and/or to enable S&F mode) is received (or transmitted/provided/broadcasted),
A configuration related to S&F mode (and/or enabled) is received (or transmitted/provided/broadcasted), and/or
S&F mode (of the UE and/or the network or network node) is enabled and/or activated.

The UE and/or the network or network node may be in normal mode (e.g., compared to S&F mode) if at least one or more of the following conditions are fulfilled:
The feeder link (of the UE and/or the network or network node) is available,
No indication of S&F mode is received (or transmitted/provided/broadcasted),
An indication to disable (or deactivate) S&F mode is received (or transmitted/provided/broadcasted),
No configuration related to S&F mode (and/or enabled) is received (or transmitted/provided/broadcasted),
A configuration to disable (or deactivate) S&F mode is received (or transmitted/provided/broadcasted), and/or
S&F mode (of the UE and/or the network or network node) is disabled and/or deactivated.

The UE and/or the network or network node may enter S&F mode from normal mode, and/or leave S&F mode to enter normal mode.

When the UE and/or the network or network node is in S&F mode (or use S&F operation), at least one or more of the following may be performed:
The UE may know (or be informed by a NW) that the NW is (or starts) using S&F to handle data (and/or signaling),
The UE may initiate a procedure to request (or indicate) the (satellite) NW to use S&F to handle data (and/or signaling),
The UE may perform data (and/or signaling) transmission that will be handled by S&F in the (satellite) NW, and/or
The UE may (be ready to) perform data (and/or signaling) reception that is stored in the (satellite) NW.

One or more configurations (/indications/parameters) related to S&F may be provided to the UE (e.g., from the network or network node, e.g., in addition to the information). The configuration (and/or the indication/parameter) related to S&F (or S&F configuration) may be associated (or specific) to an object. The object may be (or comprise) a UE, a cell, a connection (e.g., RRC connection, NAS connection), a PDU session, and/or a Quality of Service (QoS) flow. The NW may indicate (or configure) which object that the configuration (and/or the indication/parameter) is associated to. The NW may provide (at least) one configuration (and/or the indication/parameter) to (at least) one object.

The configuration (and/or the indication/parameter) related to S&F may be/comprise/be used for/indicate one or more of the following (headings):

### S&F Mode Indication

The indication may (at least) indicate whether the S&F operation is enabled or not (e.g., in the cell, for the UE, to the NW). The indication may (at least) indicate whether a feeder link of the NW is available or not. The indication may (at least) indicate whether the UE is allowed to use S&F operation (e.g., in the cell, to the NW).

The UE may determine (whether) to use S&F operation based on (at least) the indication. For example, if the UE receives the indication, the UE may consider the S&F operation is enabled (and/or activated). If the UE does not receive the indication, the UE may consider the S&F operation is not enabled (and/or activated). If the UE receives the indication, the UE may be allowed to use the S&F operation. If the UE does not receive the indication, the UE may not be allowed to use the S&F operation. The UE may be of a specific UE type. The UE type is illustrated below.

### UE Type

The configuration may (at least) indicate what (type of) UE is allowed to use S&F operation. The configuration may (at least) indicate what (type of) UE is allowed to perform transmission and/or reception to the NW (e.g., using S&F operation). The transmission and/or reception may be (User Plane (UP)) data and/or (Control Plane (CP)) signaling.

The UE type (e.g., a first type) may be based on (or identified by/represented by/specific to) UE capability, UE mobility, QoS characteristic of UE, UE status. The UE type may be (or comprise) (at least) an enhanced Machine-Type Communication ((e)MTC) UE, Narrowband Internet-of-Things (NB-IoT) UE, Reduced Capability (RedCap) UE, UE supporting New Radio (NR), UE supporting 5GC, UE supporting NTN, UE supporting regenerative payload, UE with Global Navigation Satellite System (GNSS), and/or a UE supporting S&F operation. The UE type may be (or comprise) (at least) a stationary UE, low mobility UE, and/or a UE within a limited area. The UE type may be (or comprise) (at least) a UE with a low QoS requirement, and/or a UE without Ultra-Reliable Low-Latency Communication (URLLC).

The configuration may (also) be pre-configured. For example, a first type of UE is allowed to use S&F operation if the UE receives the S&F mode indication. For example, a first type of UE is (always) allowed to use S&F operation.

The UE may determine (whether) to use S&F operation based on (at least) the configuration. For example, if the UE receives the configuration and/or the UE belongs to a UE type in the configuration (or pre-configuration), the UE may consider the S&F operation is enabled (and/or activated, and/or allowed). If the UE receives the configuration and/or the UE does not belong to a UE type in the configuration (or pre-configuration), the UE may consider the S&F operation is not enabled (and/or activated, and/or allowed). If the UE does not receive the configuration, the UE may consider the S&F operation is not enabled (and/or activated, and/or allowed).

### Traffic Type

The configuration may (at least) indicate what (type of) traffic is allowed to use S&F operation. The configuration may (at least) indicate what (type of) traffic is allowed to be transmitted to the NW (e.g., using S&F operation). The traffic may be (UP) data and/or (CP) signaling. The traffic may be Access Stratum (AS) level and/or NAS level. The configuration may (also) be pre-configured. The configuration may be based on a QoS requirement of the traffic (or the traffic type).

The traffic (or the traffic type) may be based on (or identified by/represented by/specific to) a QoS flow, PDU session, radio bearer (Signaling Radio Bearer (SRB) and/or Data Radio Bearer (DRB)), Radio Link Control (RLC) bearer, and/or a logical channel.

An explicit configuration may be used for some traffic (or traffic type), and an implicit configuration (or pre-configuration) may be used for some (other) traffic (or traffic type). For example, whether a first traffic (or traffic type) is allowed to use S&F operation may be based on the configuration. Whether a second traffic (or traffic type) is allowed to use S&F operation may be based on the pre-configuration (e.g., allowed, not allowed, without configuration).

The UE may determine (whether) to use S&F operation (e.g., for a specific traffic or traffic type) based on (at least) the configuration. For example, if the UE receives the configuration and/or the traffic of the UE is included in the configuration (or pre-configuration), the UE may consider the S&F operation is (or is not) enabled (and/or activated, and/or allowed), e.g., for the traffic. If the UE receives the configuration and/or the traffic of the UE is not included in the configuration (or pre-configuration), the UE may consider the S&F operation is not (or is) enabled (and/or activated, and/or allowed), e.g., for the traffic. If the UE receives the configuration and/or the traffic of the UE could fulfill the condition/limitation/restriction/requirement of the configuration (or pre-configuration), the UE may consider the S&F operation is enabled (and/or activated, and/or allowed), e.g., for the traffic. If the UE receives the configuration and/or the traffic of the UE cannot fulfill the condition/limitation/restriction/requirement of the configuration (or pre-configuration), the UE may consider the S&F operation is not (or is) enabled (and/or activated, and/or allowed), e.g., for the traffic. If the UE does not receive the configuration, the UE may consider the S&F operation is (or is not) enabled (and/or activated, and/or allowed), e.g., for every (or all) traffic of the UE.

If the UE considers S&F operation is allowed/enabled/activated for a traffic, the UE may perform a transmission (and/or reception) of the traffic (e.g., using S&F operation), initiate a procedure to (or for) performing transmission (and/or reception) of the traffic (e.g., using S&F operation), and/or to request a permission/establishment/resource for the traffic (e.g., using S&F operation). The procedure may be a registration procedure (e.g., for initial and/or mobility update), service request procedure, a PDU session establishment (or modification) procedure.

### QoS Parameter

The parameter may be used by the UE (e.g., based on at least the parameter) to determine (at least) whether a QoS requirement of a UE request (e.g., for a service, connection, PDU session, and/or a QoS flow) can be fulfilled. The parameter may be used by the UE (e.g., based on at least the parameter) to (at least) determine whether to initiate a UE request (e.g., for a service, connection, PDU session, and/or a QoS flow).

The parameter may be (at least) based on (or identified by/represented by/specific to) a UE, a connection, a service, a PDU session, and/or a QoS flow. The configuration may (at least) indicate what type of UE, connection, service, PDU session, and/or QoS flow is associated to the parameter. The parameter may be (at least) based on (or identified by/represented by/specific to) a radio bearer (SRB and/or DRB), RLC bearer, and/or logical channel. The configuration may (at least) indicate what type of radio bearer, RLC bearer, and/or logical channel is associated to the parameter.

The parameter may be (or comprise) (at least) a QoS Flow Identifier (QFI), 5G QoS Identifier (5QI), Allocation and Retention Priority (ARP), resource type, priority level, packet error rate, averaging window, delay budget (e.g., packet delay budget), and/or data volume (maximum data burst volume).

The parameter may (at least) indicate a QoS (related) level/requirement/characteristic(s) allowed to use S&F operation. The parameter may (at least) indicate a maximum QoS level (e.g., latency) that the NW can fulfill. The parameter may (at least) indicate how long the data (or signaling) received from the UE is expected to be stored by the NW before being delivered. The parameter may (at least) indicate how long the response of a UE request is (expected to be) transmitted (or received).

The UE may determine (whether) to use S&F operation (e.g., for a specific object, for a service, for a PDU session) based on (at least) the configuration. For example, if the UE receives the configuration and/or the object of the UE (or the service, or the PDU session) is included in the configuration (or pre-configuration), the UE may consider the S&F operation is (or is not) enabled (and/or activated, and/or allowed), e.g., for the object, for the service, and/or for the PDU session. If the UE receives the configuration and/or the object of the UE (or the service, or the PDU session) is not included in the configuration (or pre-configuration), the UE may consider the S&F operation is not (or is) enabled (and/or activated, and/or allowed), e.g., for the object, for the service, and/or for the PDU session. If the UE receives the configuration and/or the object of the UE (or the service, or the PDU session) could fulfill the condition/limitation/restriction/requirement of the configuration (or pre-configuration), the UE may consider the S&F operation is enabled (and/or activated, and/or allowed), e.g., for the object, for the service, and/or for the PDU session. If the UE receives the configuration and/or the object of the UE (or the service, or the PDU session) cannot fulfill the condition/limitation/restriction/requirement of the configuration (or pre-configuration), the UE may consider the S&F operation is not (or is) enabled (and/or activated, and/or allowed), e.g., for the object, for the service, and/or for the PDU session. If the UE does not receive the configuration, the UE may consider the S&F operation is (or is not) enabled (and/or activated, and/or allowed), e.g., for every (or all) object of the UE (or the service, or the PDU session).

If the UE considers S&F operation is allowed/enabled/activated for an object (or a service, or a PDU session), the UE may perform a transmission (and/or reception) of the object (or the service, or the PDU session) (e.g., using S&F operation), initiate a procedure to (or for) performing a transmission (and/or reception) of the object (or the service, or the PDU session) (e.g., using S&F operation), and/or to request a permission/establishment/resource for the object (or the service, or the PDU session) (e.g., using S&F operation). The procedure may be a registration procedure (e.g., for an initial and/or mobility update), service request procedure, PDU session establishment (or modification) procedure.

To determine whether a service (or PDU session, or UE) is allowed to use S&F operation, at least an object of the service (or PDU session, or UE) needs to fulfill the configured QoS. For example, if no object of the service (or PDU session, or UE) fulfills the configured QoS, the UE may not be allowed to use S&F operation for the service (or PDU session, or UE). If every object of the service (or PDU session, or UE) fulfills the configured QoS, the UE may be allowed to use S&F operation for the service (or PDU session, or UE). If some object(s) of the service (or PDU session, or UE) (e.g., a first object) fulfills the configured QoS and some other object(s) of the service (or PDU session, or UE) (e.g., a second object) does not fulfill the configured QoS, the UE may be allowed to use S&F operation for the first object and not allowed to use S&F operation for the second object. If some object(s) of the service (or PDU session, or UE) (e.g., a first object) fulfills the configured QoS and some other object(s) of the service (or PDU session, or UE) (e.g., a second object) does not fulfill the configured QoS, the UE may not be allowed to use S&F operation for the service (or PDU session, or UE) (e.g., including the first object and the second object). If some object(s) of the service (or PDU session, or UE) (e.g., a first object) fulfills the configured QoS and some other object(s) of the service (or PDU session, or UE) (e.g., a second object) does not fulfill the configured QoS, the UE may be allowed to use S&F operation for the service (or PDU session, or UE) (e.g., including the first object and the second object).

The object may be (or comprise) (at least) a connection, a service, a PDU session, and/or a QoS flow. The object may be (or comprise) (at least) a radio bearer, RLC bearer, and/or a logical channel.

### Data Volume

The configuration may (at least) indicate a data volume limitation allowed to use S&F operation. The configuration may (at least) indicate how much data that can be transmitted to the NW (e.g., using S&F operation). The data may be (or comprise) UP data and/or CP signaling. The data may be AS level and/or NAS level.

The configuration may be (at least) based on (or identified by/represented by/specific to) a UE, a connection, a service(s), a PDU session(s), and/or a QoS flow(s). The configuration may (at least) indicate what (or which) UE(s), connection(s), service(s), PDU session(s), and/or QoS flow(s) is associated to the configuration. The configuration may be (at least) based on (or identified by/represented by/specific to) a radio bearer(s) (SRB and/or DRB), RLC bearer(s), and/or a logical channel(s). The configuration may (at least) indicate what (or which) radio bearer(s), RLC bearer(s), and/or logical channel(s) is associated to the parameter.

The UE may determine (whether) to use S&F operation (e.g., for a specific object) based on (at least) the configuration. The UE may determine (whether) to stop the S&F operation (e.g., for a specific object) based on (at least) the configuration. The UE may determine (whether) S&F operation (e.g., for a specific object) can continue based on (at least) the configuration.

The object may be (or comprise) (at least) a UE, a connection, a service, a PDU session, and/or a QoS flow. The object may be (or comprise) (at least) a radio bearer, RLC bearer, and/or a logical channel.

For example, if the UE receives the configuration and/or the traffic of the UE (e.g., for the object) has not exceeded the data volume, the UE may (be allowed to) use S&F operation, e.g., for the traffic. If the UE receives the configuration and/or the traffic of the UE (e.g., for the object) has exceeded the data volume, the UE may not (be allowed to) use the S&F operation, e.g., for the traffic. If the UE does not receive the configuration, the UE may consider there is no data volume limitation to use the S&F operation, e.g., for the UE, for the object.

If the UE considers that S&F operation is allowed (e.g., for a traffic), the UE may perform (or continue) transmission (and/or reception) of the traffic (e.g., using S&F operation), initiate (or continue) a procedure to (or for) performing transmission (and/or reception) of the traffic (e.g., using S&F operation), and/or to request permission/establishment/resource for the traffic (e.g., using S&F operation). The procedure may be a registration procedure (e.g., for initial and/or mobility update), service request procedure, a PDU session establishment (or modification) procedure.

If the UE has transmitted data exceeding the data volume, the UE may stop the S&F operation, stop transmitting data, stop the (ongoing) procedure. If the UE has transmitted data exceeding the data volume, the UE may transmit an indication to the NW (e.g., indicating that the data volume limitation is reached), initiate a (RRC and/or NAS) connection release (request) procedure, initiate a de-registration procedure, and/or initiate a PDU session release (or modification) procedure (e.g., to release a PDU session). If the UE has transmitted data exceeding the data volume, the UE may release a (RRC and/or NAS) connection, and/or go to (RRC and/or NAS) idle mode (e.g., RRC_IDLE, Connection Management (CM)_IDLE).

The NW (or network node) may be a satellite NW. The satellite NW may be a network node, a CN node, a RAN node, AMF, SMF, MME, RAN, NG-RAN, eNB, gNB, a portion of the above, and/or a combination of the above.

The NW (or network node) may be a ground NW. The ground NW may be a network node, a CN node, a RAN node, AMF, SMF, MME, RAN, NG-RAN, eNB, gNB, a portion of the above, and/or a combination of the above.

The satellite NW and the ground NW may be mutually exclusive.

The NW (or network node) may be a cell. The NW may be a serving cell. The NW may be a neighbor cell. The NW may be a source cell. The NW may be a target cell.

The UE may be in RRC connected mode. The UE may be in RRC idle mode. The UE may be in RRC inactive mode.

The UE may be in CM idle state. The UE may be in CM connected state.

The UE may be in Register Management (RM) deregistered state. The UE may be in RM registered state.

The UE may be in a cell of an NTN. The UE may be connected to a cell of an NTN. The UE may be connected to a LEO, GEO, MEO, HEO, and/or HAPS.

The UE may be referred to as the UE, an RRC entity of the UE, or a Medium Access Control (MAC) entity of the UE.

The UE may be an NR device. The UE may be an NR-light device. The UE may be a reduced capability device. The UE may be a mobile phone. The UE may be a wearable device. The UE may be a sensor. The UE may be a stationary device.

The NW may be a network node. The NW may be a base station. The NW may be an access point.

The NW may be an eNB. The NW may be a gNB. The NW may be a gateway. The NW may be a PLMN.

Various examples and embodiments of the present invention are described below. For the methods, alternatives, concepts, examples, and embodiments detailed above and herein, the following aspects and embodiments are possible.

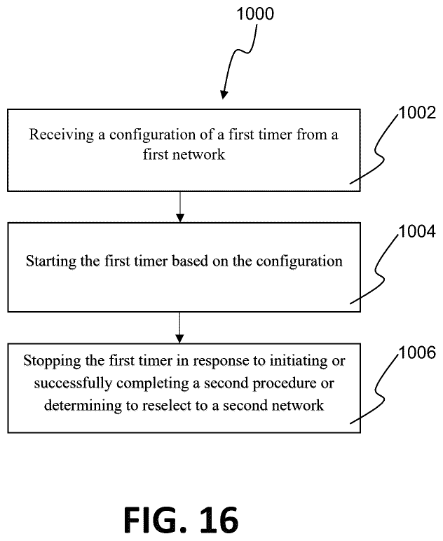

Referring to FIG. 16, with this and other concepts, systems, and methods of the present invention, a method 1000 for a UE in a wireless communication system comprises receiving a configuration of a first timer from a first network (step 1002), starting the first timer based on the configuration (step 1004), and stopping the first timer in response to initiating or successfully completing a second procedure or determining to reselect to a second network (step 1006).

In various embodiments, the first network is a first PLMN.

In various embodiments, the second network is a second PLMN.

In various embodiments, the first timer indicates a time period that the UE is prohibited to initiate a first procedure to the first network.

In various embodiments, the first timer and/or the first procedure is for S&F operation.

In various embodiments, the second procedure is not for S&F operation.

In various embodiments, the first procedure or the second procedure is an attach procedure.

In various embodiments, the first procedure or the second procedure is a TAU procedure.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a configuration of a first timer from a first network; (ii) start the first timer based on the configuration; and (iii) stop the first timer in response to initiating or successfully completing a second procedure or determining to reselect to a second network. Moreover, the CPU 308 can execute the program code 312 to perform all of the described actions, steps, and methods described above, below, or otherwise herein.

Referring back to FIGS. 3 and 4, in one or more embodiments from the perspective of a first NW in a wireless communication system, the device 300 includes a program code 312 stored in memory 310 of the transmitter. The CPU 308 could execute program code 312 to: (i) transmit a configuration of a first timer to a UE; (ii) start, at the UE, the first timer based on the configuration; and (iii) stop, at the UE, the first timer in response to initiating or successfully completing a second procedure or determining to reselect to a second network. Moreover, the CPU 308 can execute the program code 312 to perform all of the described actions, steps, and methods described above, below, or otherwise herein.

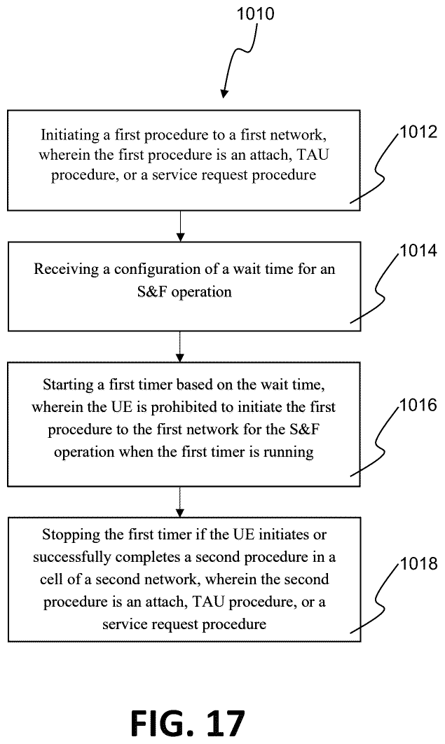

Referring to FIG. 17, with this and other concepts, systems, and methods of the present invention, a method 1010 for a UE in a wireless communication system comprises initiating a first procedure to a first network, wherein the first procedure is an attach, TAU procedure, or a service request procedure (step 1012), receiving a configuration of a wait time for an S&F operation (step 1014), starting a first timer based on the wait time, wherein the UE is prohibited to initiate the first procedure to the first network for the S&F operation when the first timer is running (step 1016), and stopping the first timer if the UE initiates or successfully completes a second procedure in a cell of a second network, wherein the second procedure is an attach, TAU procedure, or a service request procedure (step 1018).

In various embodiments, the configuration of the wait time is included in a response message of the first procedure.

In various embodiments, the first procedure is for S&F operation.

In various embodiments, the second procedure is for normal service or not for S&F operation.

In various embodiments, the first network is a satellite cell in S&F operation of a first PLMN.

In various embodiments, the second network is not a satellite cell in S&F operation of the first PLMN.

In various embodiments, the first network is indicated by a list of satellite IDs.

In various embodiments, the list of satellite IDs indicates one or more satellites over which the UE may not re-attempt the first procedure when the first timer is running.

In various embodiments, the second network is a satellite cell in normal service and/or a TN.

In various embodiments, the second network is a second PLMN.

In various embodiments, the UE is allowed to initiate the first procedure to the first network after the first timer is expired.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) initiate a first procedure to a first network, wherein the first procedure is an attach, TAU procedure, or a service request procedure; (ii) receive a configuration of a wait time for an S&F operation; (iii) start a first timer based on the wait time, wherein the UE is prohibited to initiate the first procedure to the first network for the S&F operation when the first timer is running; and (iv) stop the first timer if the UE initiates or successfully completes a second procedure in a cell of a second network, wherein the second procedure is an attach, TAU procedure, or a service request procedure. Moreover, the CPU 308 can execute the program code 312 to perform all of the described actions, steps, and methods described above, below, or otherwise herein.

Referring back to FIGS. 3 and 4, in one or more embodiments from the perspective of a first NW in a wireless communication system, the device 300 includes a program code 312 stored in memory 310 of the transmitter. The CPU 308 could execute program code 312 to: (i) be initiated with a first procedure from a UE, wherein the first procedure is an attach, TAU procedure, or a service request procedure; (ii) transmit a configuration of a wait time for an S&F operation to the UE; (iii) start, at the first UE, a first timer based on the wait time, wherein the UE is prohibited to initiate the first procedure to the first network for the S&F operation when the first timer is running; and (iv) stop, at the UE, the first timer if the UE initiates or successfully completes a second procedure in a cell of a second network, wherein the second procedure is an attach, TAU procedure, or a service request procedure. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for a User Equipment (UE), comprising:
initiating a first procedure to a first network, wherein the first procedure is an attach, tracking area update (TAU) procedure, or a service request procedure;
receiving a configuration of a wait time for a Store and Forward (S&F) operation;
starting a first timer based on the wait time, wherein the UE is prohibited to initiate the first procedure to the first network for the S&F operation when the first timer is running; and
stopping the first timer when the first timer is running if the UE initiates or successfully completes a second procedure in a cell of a second network, wherein the second procedure is an attach, TAU procedure, or a service request procedure.

2. The method of claim 1, wherein the configuration of the wait time is included in a response message of the first procedure.

3. The method of claim 1, wherein the first procedure is for S&F operation.

4. The method of claim 1, wherein the second procedure is for normal service or not for S&F operation.

5. The method of claim 1, wherein the first network is a satellite cell in S&F operation of a first Public Land Mobile Network (PLMN).

6. The method of claim 5, wherein the second network is not a satellite cell in S&F operation of the first PLMN.

7. The method of claim 1, wherein the first network is indicated by a list of satellite Identifications (IDs), and/or wherein the list of satellite IDs indicates one or more satellites over which the UE may not re-attempt the first procedure when the first timer is running.

8. The method of claim 7, wherein the second network is a second PLMN.

9. The method of claim 1, wherein the second network is a satellite cell in normal service and/or a Terrestrial Network (TN).

10. The method of claim 1, wherein the UE is allowed to initiate the first procedure to the first network after the first timer is expired.

11. A User Equipment (UE), comprising:
a memory; and
a processor operatively coupled with the memory, wherein the processor is configured to execute a program code to:
initiate a first procedure to a first network, wherein the first procedure is an attach, tracking area update (TAU) procedure, or a service request procedure;
receive a configuration of a wait time for a Store and Forward (S&F) operation;
start a first timer based on the wait time, wherein the UE is prohibited to initiate the first procedure to the first network for the S&F operation when the first timer is running; and
stop the first timer when the first timer is running if the UE initiates or successfully completes a second procedure in a cell of a second network, wherein the second procedure is an attach, TAU procedure, or a service request procedure.

12. The UE of claim 11, wherein the configuration of the wait time is included in a response message of the first procedure.

13. The UE of claim 11, wherein the first procedure is for S&F operation.

14. The UE of claim 11, wherein the second procedure is for normal service or not for S&F operation.

15. The UE of claim 11, wherein the first network is a satellite cell in S&F operation of a first Public Land Mobile Network (PLMN).

16. The UE of claim 15, wherein the second network is not a satellite cell in S&F operation of the first PLMN.

17. The UE of claim 11, wherein the first network is indicated by a list of satellite Identifications (IDs), and/or wherein the list of satellite IDs indicates one or more satellites over which the UE may not re-attempt the first procedure when the first timer is running.

18. The UE of claim 17, wherein the second network is a second PLMN.

19. The UE of claim 11, wherein the second network is a satellite cell in normal service and/or a Terrestrial Network (TN).

20. The UE of claim 11, wherein the UE is allowed to initiate the first procedure to the first network after the first timer is expired.
